(19) United States
(12) Patent Application Publication
(10) Pub. No.: US 2023/0064529 A1
(43) Pub. Date: Mar. 2, 2023

(54) User controlled identity provisioning for software applications

(71) Applicant: Swale Nunez, Brooklyn, NY (US)

(72) Inventor: Swale Nunez, Brooklyn, NY (US)

(73) Assignee: Iuncta, Inc., Brooklyn, NY (US)

(21) Appl. No.: 17/445,768

(22) Filed: Aug. 24, 2021

(51) Int. Cl. H04L 9/32; H04L 9/08

(52) U.S. Cl. CPC H04L 9/3213; H04L 9/3226; H04L 9/0825; H04L 9/0866

(57) ABSTRACT

When a user attempts to interact with a third party application the user will generally have to be authenticated to access features of the application and requested to provide user specific information to create a profile or to enable a service. Authentication and user data retrieval is done via an identity provider, in this instance the user will act as the identity provider and authenticate and share data on their own behalf with the use of a user application, which the user has to sign into with multi factor authentication, that keeps a repository of user data and the ability to approve or deny login and data request and respond accordingly. The third party applications securely communicates to a server that manages the interactions between applications. This user controlled identity provisioning alleviates the need for the author of the third party application to develop the authentication mechanism themselves.

### FIELD OF ART

This disclosure generally relates to the field of software applications and more specifically identity provisioning for online applications and services.

### BACKGROUND

Organizations who offer online services or solutions that are generally supported by software applications provide access to those applications and services via some authentication mechanism or credentials (eg. a username and password), they also provide a way to register/onboard new users as well as capture additional information (eg. payment details) which may include a data collection object such as an online form. The identity management or management of user authentication and registration is usually siloed, where each organization manages that process themselves or federated, where the organizations outsource the identity management to a third-party identity provider with an existing collection of users and their personal data. In both instances of the identity management implementation the user relinquishes control of their personal data and access to it to either the organization or the third-party identity provider being used for identity management. This in turn raises privacy and security concerns because the user generally does not know what information is being shared at the time of sharing and in some instances with whom it is being shared.

### BRIEF DESCRIPTION OF DRAWINGS

FIG. 1 Illustrates a computing environment in which a user independent of any organizational entity can control sign in or data sharing with different software applications through the use of a user application that enables it, according to one embodiment.

FIG. 2 Illustrates the relational interactions and process between the elements in FIG. 1 when verifying the identity or requesting data for authentication or data collection, according to one embodiment.

The embodiments depicted in the figures are for illustration purposes only. The principles of the invention are still maintained even if one skilled in this practice designs an alternative embodiment with the structures and methods illustrated herein.

### DETAILED DESCRIPTION

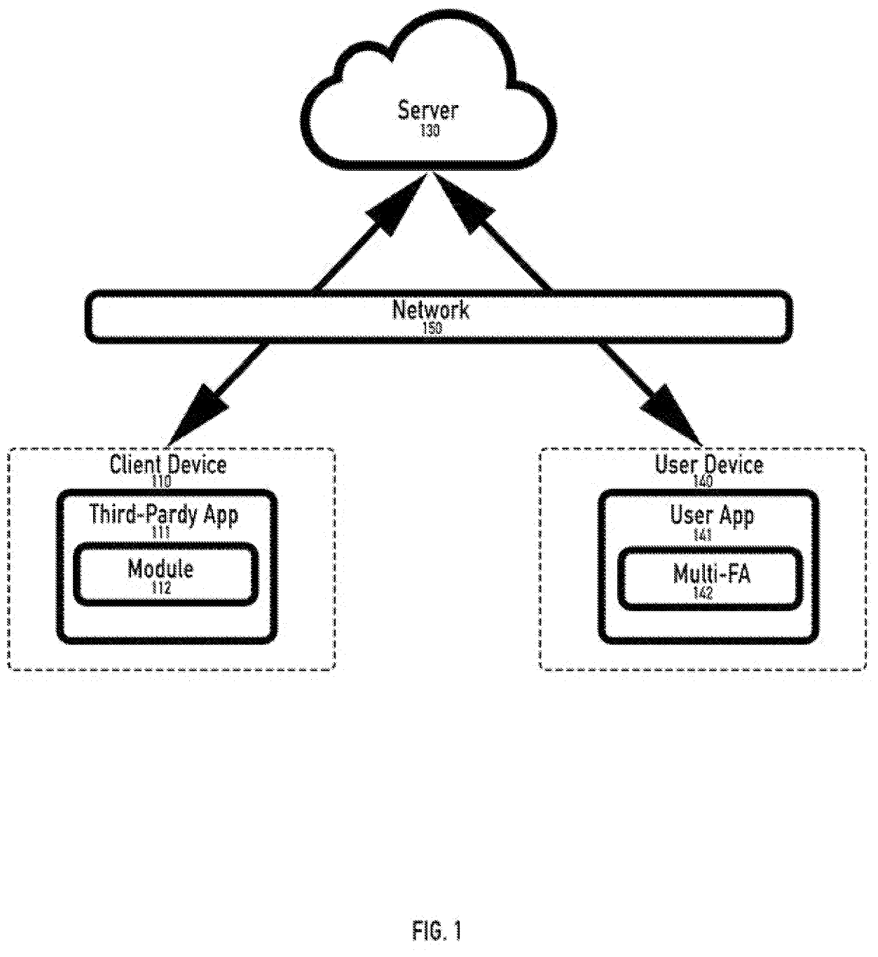

FIG. 1 Illustrates a computing environment in which a user independent of any organizational entity can control sign in or share user data with different software applications, according to one embodiment. Users interact with a number of devices 110 with each devices having a number of third-party applications 111 accessible on the devices 110. These applications 111 require some level of authentication in order to gain access to them. Access is generally managed by an identity provider and in this implementation the user themselves will act as the identity provider through the use of a unique Identifier (UID) eg. username, a module 112, the server 130 and a user application 141 that is accessible on the user device 140. The user is able to interface between the application 111 on the client device 110 and the server 130, then the application 141 on the user device 140 with the use of a software module 112 that integrates into the application 111 and serve as the gateway into the authentication mechanism. The various component will now be described in additional detail.

The client device 110 can be any device with access to third party applications 111, or can support the usage of third party applications 111. It can include computing devices such as smartphones, tablets, computers, laptops or any device that offers similar functionality and supports applications 111 usage.

A third-party application 111 is any software application that is usable via the client device 110. In one embodiment, the application interface can be rendered using web technology such as HTML/Javascript and in another instance can be rendered using a language native to the client device 110.

The module 112 is a software component that integrates into the third party applications 111. That module 112 is the gateway into the identity provider service, by inputting the UID (eg. a username) it directs the user of the application 111 running on the client device 110 to the server 130 that subsequently directs it to the user devices 140 associated with the user ID and to the application 141 for authentication and data request approval. The third party application 111 without the use of the module 112 would otherwise not be able to access the server 130 and would therefore be unable to authenticate or retrieve any user credentials, or user specific data. An integration embodiment of the module 112 can include a web rendering using HTML or an alternative web technology to render the controls and the use of a Web API (Application Programming Interface) or SDK (Software Development Kit) through which the third party applications 111 running on the client device 110 can communicate with the server 130 and subsequently the user device 140 and application 141 via a secure network 150.

The user device 140 can be any device with access to the user party application 141, or can support the usage of the user applications 141. It can include computing devices such as smartphones, tablets, computers, laptops or any device that offers similar functionality and supports application 141 usage.

The client device 110 and the user device 140, can be the same device in one embodiment.

The user application 141 is a software application usable via the user device 140 that has a direct connection to the server 130, its interface allows for the management of user profile data and enables consent and data access. The user is assigned a UID at the time of account creation and will have to perform a multi factor authentication (MFA) 142 on initial access and all subsequent access to the user application 141. The user application 141, is the mechanism through which the user controls with whom, when and what data will be shared and also used to allow or deny sign in access to third party applications 111. The application 141 in one embodiment can store user data locally on the device 140 or store it remotely on the server 130 with communication done via a secure network 150. Access to the application 141 is secured using MFA 142, in one embodiment it can included but not limited to, username and password, biometric authentication or some other mechanism to identify the user.

The Server 130 stores and manages the information and the relationship between the client device 110 and the user device 140 including their respective applications 111/141. The server 130 communicates via the secure network 150. The server comprises of both a user and client rights database that stores (eg. With encryption) user credentials, identity data, client and user authentication elements and other information that maps the relationship between the users, the applications 111/141 and the devices 110/140.

The network 150 is any acceptable network or technology medium that allows for data transmission and communication between the particular elements, an example is illustrated in the embodiment in FIG. 1.

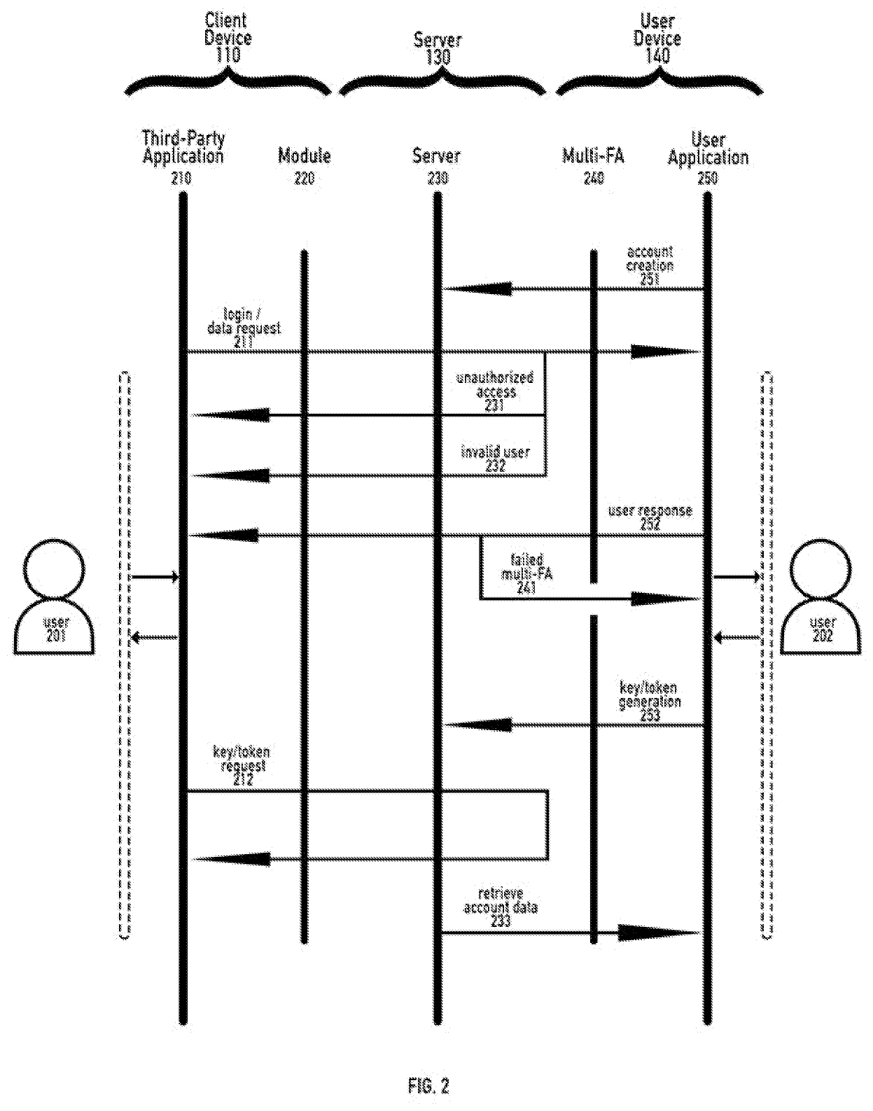

FIG. 2 Illustrates the relational interactions and process between the elements in FIG. 1 when verifying the identity or requesting data for authentication or data collection, according to an embodiment where in this instance User 201 and User 202 are the same user (USER) and accessing from the same device, meaning the client device 110 and the user device 140 is a single device, in this case a smartphone. In this embodiment the USER is trying to create a new account for the third party application 210 and initiating a data request 211 to complete the relevant fields for registration. In another embodiment the USER may already have an established account with the third party application 210 but needs additional user data (eg. requesting payment or payment related information). In that instance the user would still make a data request 211. In the previous embodiment where the USER is trying to create a new account on the third party application 210 it is assumed that the USER has an existing account in the user application 250 and has previously successfully completed the registration request 251 via a secure protocol and encrypted transport layer and the account information including user profile data and UID (eg. username) exists and is stored securely on the either the server 230 and/or the user device 140 with access to that data via the user application 250.

In this embodiment, the USER launches the third party application 210 and initiates an account creation requests 211. The User provides their UID (eg. username) to the module 220 inside application 210 that comprises but not limited to scrips and web calls that identifies the application 210 by a generated token with public and private elements which are used to validate the requests by the server 230. The server validates the request by verifying that the third party application 210 is authorized to access the server, if the request is not authorized it will be declined 231 and a response sent back to the user via the module 220 and then the third party application 210. The server 230 also validates that the USER is a known user and has an existing account based on the UID (eg. username) that the USER provided, if the user is unknown the request will be declined 232 and the response sent back to the user via the module 220 and then the third party application 210. If the request is successfully validated by the server 230, it sends a notification to the USER's device 140 via the user application 250 based on the UID (eg. username) that was entered into the module 220. The USER then launches the user application 250, and if their previous user session is no longer active, the USER will need to re-authenticate via MFA 240. Once authenticated and inside the user application 250 the user views the account creation data request and either approves or deny access to the USER specific data via a user response 252. In an instance of this embodiment the user may be required to perform an additional MFA in order to send response 252. If that MFA 240 fails 241, the response is not sent to the server 230 but the failure is routed back to the user application 250. If the MFA 240 is successful the data is routed to the server 230 then subsequently to the module 220 and finally back to the third party application 210, where the data is used to populate the fields necessary to create an account.

In another embodiment, where both the user 201 and user 202 are again the same user (USER) but the client device 110 is in this instance is a laptop with a web browser and the user device 140 is a smartphone. The USER intends to sign into a third party application 210 running in the web browser of the client device 110. In this embodiment, the USER launches the third party application 210 and initiates a login requests 211. The User provides their UID (eg. username) to the module 220 inside application 210 that comprises but not limited to scrips and web calls that identifies the application 210 by a generated token with public and private elements which are used to validate the requests by the server 230. The server validates the request as detailed in the previous embodiment and if the request is successfully validated by the server 230, it sends a notification to the USER's device 140 via the user application 250 based on the UID (eg. username) that was entered into the module 220. The USER then launches the user application 250 and assuming the user is logged in with an active session (if not, the user will have to authenticate via the MFA 240) the user will manually either approve or deny the log in request and initiate a response 252. The response will then repeat the same path back to the third party application 210 as indicated above and by the response illustrated in 252. A user approval response then authenticates the USER in the third party application 210, but a denial response prevents the USER from gaining access to the third party application.

In another embodiment, where the user 201 and user 202 are two different users each having separate devices with the user 201 client device 140 being a smartphone and the user 202 user device 140 also being a smartphone. User 201 has asked user 202 to share his/her UID (eg. username) with them in order to sign into a third party application 210 with user 202's credentials. User 202 can share his UID (eg. username) and approve the sign in as detailed in the previous embodiment or in FIG. 2 with the login request 211 and the responding user response 252.

Or in an alternative embodiment, instead of user 202 sharing his UID (eg. username) with user 201 for user 202 to subsequently approve access, user 202 can generate a temporary UID (eg. key or token) which may or may not expire and becomes invalid after a predefined time has elapsed. User 202 launches the user application 250 and authenticates via MFA 240, while inside the application 250 user 202 generates a temporary UID (eg. key or token), a copy of the temporary UID is securely sent 253 to the server 230 and is stored and remains active until the pre-defined time has elapsed. User 202 then shares that temporary UID with user 201. User 201 then launches the third party application 210 he/she intends to log into using user 202's credentials and enters the temporary UID (eg. key or token) into the module 220 for authentication and initiates key/token login requests 212. The module 220 inside application 210 that comprises but not limited to scrips and web calls that identifies the application 210 by a generated token with public and private elements which are used to validate the requests by the server 230. The server validates the request as detailed in the previous embodiment. After the server 230 successfully validates the request, the server recognizes that a temporary UID is being used, and based on the components of the temporary UID, the server 230 can identify which user generated the token, in this embodiment the user 202 has been identified by the server 230. The server 230 then retrieves the copy of the temporary UID that was generated by user 202 and compares it to the temporary UID provided by user 201. If the temporary UID's match and the pre-defined time has not elapsed, meaning the temporary UID is still valid, the server 230 response with an approval request back to the third party application 210 via the module 220 that allows user 201 to authenticate into the third party application 210 as user 202. If either a temporary UID mismatch occurs on the server 230 during validation or the preset time has elapsed on the generated temporary UID, the server 230 will return a deny response back to the third party application 210 via the module 220 that will prevent the user 201 from gaining access to the third party application 210.

The interactions in FIG. 2 can be interpreted with multiple different embodiments and the precise interactions and/or the order of those interactions can vary with each embodiment.

### OTHER CONSIDERATIONS

The detailed description of the present invention is not only limited to the embodiments used to describe the invention, those skilled in the art would be able to effectively understand and demonstrate other embodiments of said invention. The naming of elements and individual components, the alternate display of terms, data structures and other structural or programming aspects is not mandatory or of any significance, the different parts of the invention or the features associated with them may be named differently or used alternative protocols or formats. Many variations and modifications are possible, the embodiments chosen to describe the technology were done so in order to best explain the principles of the invention and illustrate practical implementations. The disclosures made by this invention are intended to serve as an illustration but it should not limit the scope of the invention defined by the claims appended here to.

What is claimed:

1. A computer-implemented method for facilitating user-controlled authentication and data retrieval to third party applications on a client device, the method comprising:
A user application on a user device that enables a user to act as their own identity provider, the user application provides a unique identifier, takes user data as input and stores data specific to a user, the user application is the mechanism through which a user can authorize access to third party applications or approve the sharing of user specific data;
a server that generates a token comprising a public token portion and a corresponding private portion, the server manages access, via a network, between the third party application on the client device and the user application on the user device, the server also stores relevant data mapping information relating to identity and access management of the client and user and stores the relevant credentials and records associated with their respective identities;
the server registers both the third party application and the user application including storing relevant data that uniquely identifies both, that can be used to authenticate and validate requests from either;
the third party application being used on the client device by the user initiates a request for access or data for a user by inputting a unique identifier associated with a user into a module that allows access to the server via a network;
the module comprises of but not limited to scripts, web calls that interfaces directly with the server via a network, and uses encryption protocols that may include a token, and public and private keys to ensure a secure transmission of data;
the request is transmitted, via the network, from the client device to the server and subsequently to the user device;
the server validates and check the authority of the request with the use of tokens before passing it to the user device and user application associated with the unique identifier;
the user of the user application, once authenticated through multi factor authentication, then performs the service of the identity provider themselves, by manually responding to the request for sign in by either approving or denying access or if it is a data request, provide or withhold the relevant data;
Once the response has been initiated it is transmitted, via the network, from the user device back to the server and subsequently the client device;
The user, identified by the unique identifier and verified by multi factor authentication within the user application, acting as the identity provider authenticated the user of the third party application.

2. A computer-implemented method for facilitating user-controlled authentication into third party applications on a client device using a unique identifier generated on demand, the method comprising:
A user application on a user device that enables a user to act as their own identity provider (IDP), the user application generates a unique identifier at the request of the multi factor authenticated user that is associated with the user, the generated unique identifier is the mechanism through which a user can authorize access to third party applications;
a server that generates a token comprising a public token portion and a corresponding private portion, the server manages access, via a network, between the third party application on the client device and the user application on the user device, the server also stores relevant data mapping information relating to identity and access management of the client and user and stores the relevant credentials and records associated with their respective identities, a copy of the generated unique identifier generated in the user application is stored on the server;
the server registers both the third party application and the user application including storing relevant data that uniquely identifies both, that can be used to authenticate and validate requests from either;
the third party application being used on the client device by the user initiates a request for authentication and access for a user by inputting the generated unique identifier generated in the user application associated with a user into a module that allows access to the server via a network;
the module comprises of but not limited to scripts, web calls that interfaces directly with the server via a network, and uses encryption protocols that may include a token, and public and private keys to ensure a secure transmission of data;
the request is transmitted, via the network, from the client device to the server;
the server validates and check the authority of the request with the use of tokens; because a copy of the generated unique identifier was already sent to the server by the user application, the server compares that copy to the generated unique identifier in the request and avoids having to back to the user application for consent;
if the copy of the generated unique identifier in the request from the third party application matches the copy that was sent to the server by the user application, the sever responds by granting access, if the copies do not match the server responds with a deny access response;
Once the response has been initiated it is transmitted, via the network, from the server back to the client device;
The user, who entered the generated unique identifier into the third party application is now authenticated by the user who generated the unique identifier using the user application.

3. The computer-implemented method from claim 1, further comprising:
A unique identifier provided by a component of the system other than the user application.

4. The computer-implemented method from claim 1, further comprising:
A unique identifier that isn't of a single format and can be represented in multiple different ways and can also be constructed using any attributes specific to any of the elements or the features of the overall system.

5. The computer-implemented method from claim 1, further comprising:
The server communicating to the user application and third party applications via push notifications.

6. The computer-implemented method from claim 1, further comprising:
The module in the third party application on the client device polling the server for a response from the user application.

7. The computer-implemented method from claim 1, further comprising:
The module in the third party application on the client using a programming language native to the client device.

8. The computer-implemented method from claim 1, further comprising:
The user application communicating to the server using secure web protocols including a public and corresponding private token.

9. The computer-implemented method from claim 2, further comprising:
A unique identifier that isn't of a single format and can be represented in multiple different ways and can also be constructed using any attributes specific to any of the elements or the features of the overall system.

10. The computer-implemented method from claim 2, further comprising:
The module in the third party application on the client using a programming language native to the client device.

11. The computer-implemented method from claim 2, further comprising:
A generated unique identifier that was created to be used by a specific third party application with the mapping assigned at creation time by the user in the user application, which means that the generated unique identifier would not be valid for use by any other third party application with access to the server.
